(19) United States
(12) Patent Application Publication
(10) Pub. No.: US 2020/0019494 A1
(43) Pub. Date: Jan. 16, 2020

(54) METHOD AND APPARATUS FOR PERFORMING TEST BY USING TEST CASE

(71) Applicant: SPARRIW CO., LTD, Seoul (KR)

(72) Inventor: Oh Seung KWON, Yongin-si (KR)

(21) Appl. No.: 16/486,079

(22) PCT Filed: Feb. 28, 2018
(86) PCT No.: PCT/KR2018/002452

§ 371 Date: Aug. 14, 2019

(30) Foreign Application Priority Data
Feb. 28, 2017 (KR) 10-2017-0026398

(51) Int. Cl. G06F 11/36; G06F 16/22; G06F 16/242

(52) U.S. Cl. CPC G06F 11/3688; G06F 16/242; G06F 16/2246; G06F 11/3684

(57) ABSTRACT

Disclosed is a test method and apparatus using a test case. The test method using a test case comprises the steps of: generating a test case for a source code including a structured query language (SQL) statement on the basis of symbolic execution; and performing a test by applying the test case to a system to be tested, which interworks with a database. Therefore, a test case is automatically generated, and thus, the effort and time required for a test can be dramatically reduced.

### TECHNICAL FIELD

The present invention relates to a method and an apparatus for test using a test case, and more particularly, to a method and an apparatus of automatically generating a test case for finding a system error in a development process of a business system and testing the system by using the generated test case.

### BACKGROUND ART

Test methods include a static test that statically tests a source code without actually executing a program, and a dynamic test that tests a program by actually executing the program and checking returned execution results.

The static test is a method of analyzing a pattern and a process flow of a source code to detect an error. In the static test, a test case may be found or test case values may be generated, and a developer may test a program using the test case.

The dynamic test requires an input value because an operation of the program should be tested, and an output value is generated as a result of the operation of the program. Also, when testing the operation of the program, a basic unit may be a function which is the minimum module of the program. Here, the function has an input parameter and an output parameter, and the function may return a value.

One of the existing test case generation studies (e.g., Gupta et al.) has automatically generated test data by using iterative mitigation techniques. Specifically, a test case is selected based on a basis path, and a solution is obtained using a Gaussian elimination scheme. Here, the obtained solution is a test path value. However, these studies did not consider SQL query statements that are often used in enterprise business systems, and when the number of variables increases, there is a problem that cannot be solved by the Gaussian elimination scheme.

In one of other studies (e.g., Godefroid et al.), a test case is generated by combining symbolic execution and concrete execution. Specifically, variables affecting external environments are derived using a random test scheme, a code insertion scheme, and a symbolic execution scheme, an initial value is generated by using the random test scheme in which a test case is randomly generated using the derived variables, and execution results are analyzed through an instrumentation code. However, this study has a problem that it is difficult to be considered as symbolic execution in the strict sense.

In addition, another study (Sen et al.) to generate a test case by combining symbolic execution and concrete execution defines and uses a C-like language for the symbolic execution, and is mainly used to find NULL pointers. However, since it does not explicitly generate and manage a test case, there are a problem of reparsing an entire source code every time, and a problem of not considering any SQL query statements.

If a database environment is not considered, when an enterprise system is tested, data in the database may be changed by SQL query statements for registration, modification, and deletion, these change may affect the test results, and precise testing cannot be performed.

### DISCLOSURE

### Technical Problem

An objective of the present invention for solving the above-described problem is to provide a test method using a test case.

Another objective of the present invention for solving the above-described problem is to provide an apparatus for generating a test case.

Another objective of the present invention for solving the above-described problem is to provide a test apparatus using a test case.

### Technical Solution

The present invention for solving the above-described problem provides a test method using a test case.

Here, a test method using a test case may comprise generating a test case for a source code including a structured query language (SQL) statement based on symbolic execution; and performing a test by applying the test case to a system-under-test, which interworks with a database.

Here, the test case may include at least one of an input value of the system-under-test, an expected output value predicted as an output value when the input value is processed in the system-under-test, a setting value for the database, and an expected result value predicted to be stored in the database when the system-under-test interworks with the database.

Here, the generating of the test case may comprise determining at least one program path for the source code; performing the symbolic execution according to the at least one program path; and generating the test case using a solver for a logical expression generated according to the symbolic execution.

Here, the determining of the at least one program path may comprise parsing the source code to generate an abstract syntax tree (AST); generating a control flow graph (CFG) based on the generated abstract syntax tree; and determining the at least one program path based on the control flow graph.

Here, the performing of the symbolic execution may comprise, when an SQL statement is included in the at least one program path, mapping a column of a table included in the database according to a host variable and the SQL statement of the source code.

Here, the mapping may comprise parsing the SQL statement to identify the table; acquiring the column constituting the identified table using metadata of the database; and mapping the acquired column to the host variable of the source code.

The test method may further comprise, after the generating of the test case, storing the generated test case in one of XML and JSON formats.

Here, when the system-under-test is a module, the performing of the test case may comprise applying the setting value to the database; configuring an input parameter of the system-under-test with the input value; calling a function of the system-under-test with the configured input parameter; and comparing an output value of the system-under-test obtained as a result of calling the function with the expected output value, and comparing a result value stored in the database with the expected result value.

Here, when the system-under-test is a middleware service, the performing of the test case may comprise generating an input document using the test case; calling a service of a middleware with which the system-under-test interworks, and transmitting the input document to the middleware; and receiving a test result document from the middleware.

Here, the middleware may be configured to identify the database setting value of the test case from the input document; perform an initial setting on the database using the identified database setting value; identify the input value of the test case from the input document; and execute the system-under-test by inputting the input value as an input parameter of the system-under-test.

Here, when an output value of the system-under-test is changed at each execution of the system-under-test, the expected output value may be excluded from the test case, or determined by one of a macro, a reference, or a script.

An aspect of the present invention for achieving another objective provides a test case generating apparatus.

Here, an apparatus for generating a test case may comprise a process executing at least one instruction and a memory storing the at least one instruction. When the at least one instruction is executed, the processor may be configured to determine at least one program path for a source code including a structured query language (SQL) statement based on symbolic execution; perform the symbolic execution according to the at least one program path; and generate a test case by using a solver for a logical expression generated according to the symbolic execution.

Here, the processor may be further configured to generate an abstract syntax tree (AST) by parsing the source code; generate a control flow graph (CFG) based on the generated abstract syntax tree, and determine the at least one program path based on the control flow graph.

An aspect of the present invention for achieving another objective provides a test apparatus using a test case.

Here, a test apparatus using a test case may comprise a process executing at least one instruction and a memory storing the at least one instruction. When the at least one instruction is executed, the processor may be configured to generate a test case for a source code including a structured query language (SQL) statement based on symbolic execution; and perform a test by applying the test case to a system-under-test, which interworks with a database. The test case may include at least one of an input value of the system-under-test, an expected output value predicted as an output value when the input value is processed in the system-under-test, a setting value for the database, and an expected result value predicted to be stored in the database when the system-under-test interworks with the database.

Here, the processor may be configured to determine at least one program path for the source code; perform the symbolic execution according to the at least one program path; and generate the test case using a solver for a logical expression generated according to the symbolic execution.

Here, the processor may be configured to parse the source code to generate an abstract syntax tree (AST); generate a control flow graph (CFG) based on the generated abstract syntax tree; and determine the at least one program path based on the control flow graph.

Here, the processor may be configured to, when an SQL statement is included in the at least one program path, map a column of a table included in the database according to a host variable and the SQL statement of the source code.

Here, the processor may be configured to parse the SQL statement to identify the table; acquire the column constituting the identified table using metadata of the database; and map the acquired column to the host variable of the source code.

Here, the processor may be configured to store the generated test case in one of XML and JSON formats.

Here, the processor may be configured to, when the system-under-test is a module, apply the setting value to the database; configure an input parameter of the system-under-test with the input value; call a function of the system-under-test with the configured input parameter; and compare an output value of the system-under-test obtained as a result of calling the function with the expected output value, and compare a result value stored in the database with the expected result value.

Here, the processor may be configured to, when the system-under-test is a middleware service, generate an input document using the test case; call a service of a middleware with which the system-under-test interworks, and transmit the input document to the middleware; and receive a test result document from the middleware.

### Advantageous Effects

When the test method and apparatus using a test case according to the present invention as described above are used, a test case for iterative testing can be provided, and thus there is an advantage that it can be used in a regression test for finding regression errors.

In addition, test cases can be generated by considering embedded SQL statements included in a program, so that it can be made easy to test a system interworking with a database.

In addition, test cases are generated automatically, which can greatly reduce effort and time required for the testing.

### DESCRIPTION OF DRAWINGS

FIG. 1 is a conceptual diagram illustrating a test method using a test case according to an exemplary embodiment of the present invention.

FIG. 2 is a flowchart of a test method using a test case according to an exemplary embodiment of the present invention.

FIG. 3 is a flowchart illustrating a step of determining a program path according to an exemplary embodiment of the present invention.

FIG. 4 is a conceptual diagram for explaining an abstract syntax tree (AST) according to an exemplary embodiment of the present invention.

FIG. 5 is an exemplary diagram of a source code for deriving a test case according to an exemplary embodiment of the present invention.

FIG. 6 is a conceptual diagram for explaining a control flow graph (CFG).

FIG. 7 is a diagram illustrating a result of simulating symbolic execution process for a path 6.

FIG. 8 is a first exemplary diagram illustrating a process of performing a test according to an exemplary embodiment of the present invention.

FIG. 9 is a second exemplary diagram illustrating a process of performing a test according to an exemplary embodiment of the present invention

### MODES OF THE INVENTION

While the present invention is susceptible to various modifications and alternative forms, specific embodiments are shown by way of example in the drawings and described in detail. It should be understood, however, that the description is not intended to limit the present invention to the specific embodiments, but, on the contrary, the present invention is to cover all modifications, equivalents, and alternatives that fall within the spirit and scope of the present invention.

Although the terms “first,” “second,” etc. may be used herein in reference to various elements, such elements should not be construed as limited by these terms. These terms are only used to distinguish one element from another. For example, a first element could be termed a second element, and a second element could be termed a first element, without departing from the scope of the present invention. The term “and/or” includes any and all combinations of one or more of the associated listed items.

It will be understood that when an element is referred to as being “connected” or “coupled” to another element, it can be directly connected or coupled to the other element or intervening elements may be present. In contrast, when an element is referred to as being “directly connected” or “directed coupled” to another element, there are no intervening elements.

The terminology used herein is for the purpose of describing particular embodiments only and is not intended to be limiting of embodiments of the present invention. As used herein, the singular forms “a,” “an,” and “the” are intended to include the plural forms as well, unless the context clearly indicates otherwise. It will be further understood that the terms “comprises,” “comprising,” “includes,” and/or “including.” when used herein, specify the presence of stated features, integers, steps, operations, elements, parts, and/or combinations thereof, but do not preclude the presence or addition of one or more other features, integers, steps, operations, elements, parts, and/or combinations thereof.

Unless otherwise defined, all terms (including technical and scientific terms) used herein have the same meaning as commonly understood by those of ordinary skill in the art to which the present invention pertains. It will be further understood that terms defined in commonly used dictionaries should be interpreted as having a meaning that is consistent with their meaning in the context of the related art and will not be interpreted in an idealized or overly formal sense unless expressly so defined herein.

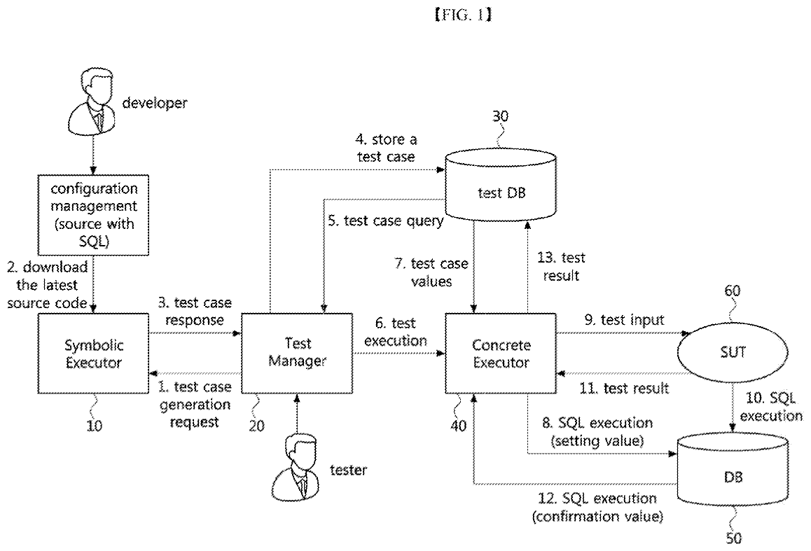

Hereinafter, exemplary embodiments of the present invention will be described in greater detail with reference to the accompanying drawings. FIG. 1 is a conceptual diagram illustrating a test method using a test case according to an exemplary embodiment of the present invention.

Referring to FIG. 1, a test method using a test case according to an exemplary embodiment of the present invention may be performed by a test apparatus including a symbolic executor 10, a test manager 20, and a concrete executor 40.

Here, the test apparatus may include a separate test database 30 inside or outside.

A test method according to an exemplary embodiment of the present invention will be described. First, the test manager 20 may receive a test case generation request from a tester. The test manager 20 may request the symbolic executor 10 to generate a test case. The symbolic executor 10 requested to generate a test case may download a source code from a configuration management. Here, the configuration management may be an entity managing the latest source code so that a test reflecting changes of the source code even when the source code or a database table is changed at any time during a development process, and the source code may be interpreted as including a structured query language (SQL) statement. Also, the source code downloaded here may be directly input to the symbolic executor 10 by a developer.

The symbolic executor 10 may generate a test case and transmit it to the test manager 20. The test manager 20 may store the received test case in a test DB 30. The stored test case may be provided to the tester through the test manager 20 when the tester requests an inquiry through the tester manager 20.

The test manager 20 may request the concrete executor 40 to execute a test. The concrete executor 40 requested to execute the test may inquire a test case from the test DB 30, and may apply setting values for the test to a database 50 interworking with a system-under-test (SUT) 60 according to the inquired test case. Here, the setting values for the test may be initial values that should be stored in the database 50 in order for the system-under-test 60 to operate in conjunction with the database 50. In some cases, the initial values may be absent or null values.

The concrete executor 40 may obtain an output value of the system-under-test 60 by inputting an input value from the inquired test case to the system-under-test 60.

Also, when the system-under-test 60 receives the input value and operates, a new result value may be stored in the database 50 interworking with the system-under-test. Therefore, the concrete executor 40 may also acquire the result value from the database.

The concrete executor 40 may compare the acquired output value of the system-under-test 60 and the result value of the database 50 with a confirmation value stored in the test DB 30, and may diagnose and identify whether or not an error is in the system-under-test 60 through the comparison.

Then, the concrete executor 40 may store the test result in the test DB 30 and return the test result to the test manager 20. The test manager 20 may provide the returned test result to the tester.

Through these procedures, the test case may be generated, stored, and executed, and the test result may be stored. Also, a series of test life cycles, including statistics and reports on the test result, may be supported.

Here, the symbolic executor 10 may use meta-information provided by the database 50 to obtain columns of a table necessary for understanding the SQL query statements and constraints of the respective columns when performing symbolic operations.

The test manager 20 may store and manage a test path, a test case, and a test result value according to the test path in the test DB 30 in an extensible markup language (XML) format, which is an international standard.

Further, synchronization between the test case and the system-under-test 60 may be required so that the test can be performed using the test case reflecting the latest source code. A test case may be generated by identifying the change from the configuration management each time the system-under-test 60 is changed.

Alternatively, a test case may be generated by checking whether or not the system-under-test 60 is the latest from the configuration management only at a time when a test is requested.

Specifically, when the test manager 20 receives a test request from a user or an administrator, the test manager may check whether a test case has been generated in the test DB 30. When there is a test case and there are no new modifications (or, when the test case is a test case generated for the latest source code), the test manager may request a test by forwarding an identifier of the test case and an identifier of the system-under-test 60 to the concrete executor 40. Also, when there is no test case in the test DB 30 or the test case is not generated based on the latest system-under-test 60, the test manager may request the symbolic executor 10 to generate a test case.

The concrete executor 40 may retrieve a test case stored in the test DB 30 to execute a test, generate a driver or a document with the values, execute the test, and store and manage a test result value in the test DB 30.

The configuration management manages all the source codes to be tested, and the symbolic executor 10 may generate a test case for the latest source code.

The system-under-test 60 may be a module or a service to be tested.

For example, a module may exist in form of a source code, an object code, a static library, and a dynamic library. The service may also be a binary type program running under a middleware base. The service may be tested through a document.

There are location-based and tag-based documents. In the location-based document, the meaning of data may be defined by the location and length of data. In the tag-based document, the meaning of the data is defined by a tag, and the tag-based document may have a form such as JavaScript Object Notation (JSON) and Extensible Markup Language (XML).

The test manager 20 may provide various test results to the developer, a quality assurance person, and a project manager in form of statistical and status reports. These reports may include the status of testing by project, the status of testing by task, the status of testing by module or service, and results of excluding or dealing with defects.

In addition, the test manager 20 may support unit tests, integration tests, and regression tests. A test case generated for the unit test may also be used in the integration and regression tests. The integration test consists of a scenario, which can be organized by combining unit test cases in sequence. In order to combine unit test cases into a scenario, actual output values of the previous test case may have to be mapped to the input values. Also, an arithmetic expression for mapping expected output values to the input values may be provided. The test cases of the unit tests may be used as the test cases to be used in the regression test without modification, but a method for selecting various test cases according to the regression analysis may be necessary. That is, in the scope of regression analysis, a technique such as selecting test cases by program dependency, selecting test cases by function dependency, and selecting only the affected test cases may be applied.

Here, the symbolic executor 10, the test manager 20, and the concrete executor 40 have been described as individual entities for convenience of explanation. However, it should be understood that they may be not implemented as the individual entities but some of them may be implemented as combined in one entity. They are not construed as limited to the exemplary embodiment.

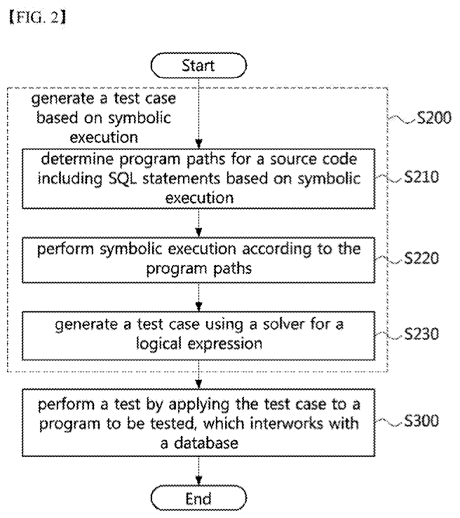

FIG. 2 is a flowchart of a test method using a test case according to an exemplary embodiment of the present invention.

Referring to FIG. 2, a test method using a test case may include a step S200 of generating a test case for a source code including a structured query language (SQL) statement based on symbolic execution, and a step S300 of performing a test by applying the test case to a system-under-test, which interworks with a database.

Here, the test case may include at least one of an input value of the system-under-test, an expected output value predicted as an output value when the input value is processed in the system-under-test, a setting value for a database, and an expected result value predicted as a result value be stored in the database when the system-under-test interworks with the database to which the setting value is applied.

Specifically, the input value may be a value corresponding to an input parameter of a function, the expected output value may be a value corresponding to an output parameter to identify a result returned after the function is executed, the setting value may be an initial value that should be stored in the database in order for the system-under-test to interwork with the database, and the expected result value may be a value that can be stored in the database as a result of the system-under-test operated in conjunction with the database.

Also, the input value and the expected output value or the expected result value may be have a type such as an integer or a string according to a data type of the input parameter, a return type (or, output parameter), or a data stored in the database, and the database setting value may be an SQL query statement composed of at least one of INSERT, UPDATE, and DELETE statements.

In addition, a test case including at least one of the input value, the expected output value, the database setting value, and the expected result value may be stored in one of a JavaScript Object Notation (JSON) format and an Extensible Markup Language (XML) format. However, the embodiment is not limited thereto, and the test case may be stored in a form of a string, a binary, or the like.

Here, the source code may mean a source code of the system-under-test.

In addition, the source code may include SQL statements, where the source code may include various codes written in commercial languages, including JAVA, Swift, Object C, and the like. In some cases, the source code may be an individually-defined language by removing some of syntaxes from the commercial language. In particular, the SQL statements included here may be defined as embedded SQL. For example, there may be Oracle's PL/SQL, PostgreSQL's ECPG, Sybase's ASE, etc. These embedded SQL-supported languages may include C/C++, COBOL, PL/1, and the like.

Although an exemplary source code of the present invention is described in a commercial language by removing some of its syntaxes for convenience of explanation, the present invention is not limited thereto and may be applied to various programming languages.

Here, the system-under-test may be an information system using a database.

Here, the database may store at least one table each of which stores one or more records and has at least one attribute for each record.

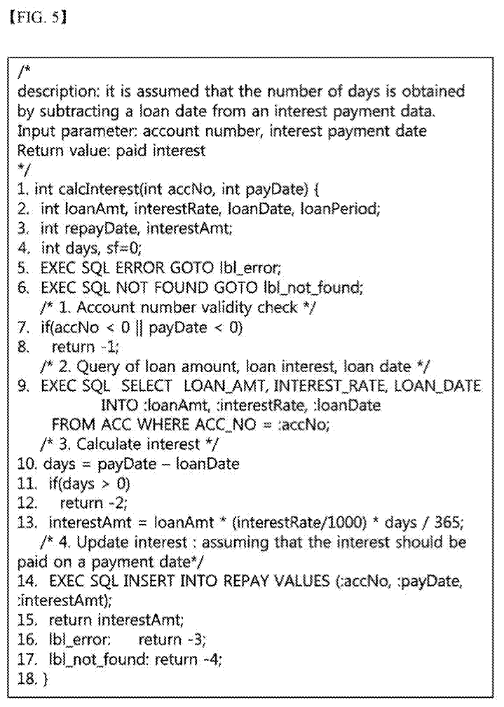

Hereinafter, a system-under-test according to an exemplary embodiment of the present invention will be explained as an example a business interest calculation program interworking with a database. However, the system-under-test is not limited to a specific system, and an exemplary source code of the business interest calculation program may be referred to in FIG. 5 below.

Here, symbolic execution refers to using a value defined by a symbol instead of a specific value in order to analyze a program, and will be described based on the following exemplary source code.

TABLE 1

int bar(int a) { // a=A : a is set with a symbol A
b = a * 10 + 1; // b = A*10 + 1
if(b != 31) { // (A*10 + 1) != 31
return 0; //error // A != 3 : (...,−2,−1,0,1,2,4,5,...)
} else {
return 1; //ok // A == 3
}
}

Referring to Table 1, symbolic execution may described for the exemplary source code. First, ‘a’ defined as an input parameter may be assigned ‘A’ as a symbol value. Therefore, the arithmetic expression b=a*10+1 becomes b=A*10+1, which may be directly assigned to a variable ‘b’. When a case that a conditional statement IF expression is established is calculated on the basis of A, A !=3, so that A may be a various integer (int) except 3.

On the other hand, when a case that the conditional statement IF expression is not established (i.e., ‘else’ statement) is calculated on the basis of A, 3 may be derived as symbolic A (i.e., A=3).

Here, various solvers may be used for the calculation of the conditional expression composed of the symbol value as described above. For example, Z3, which Microsoft has released for research, may be used.

Meanwhile, if the symbolic expression is nonlinear, for example, a*b=10 or sin(a)=1, it may be difficult to use the solver for the calculation. In this case, it can be solved by changing it to a linear condition by using a method of assigning an actual specific value to one of symbol values, or the like.

Here, an example of a table stored in a database interworking with the system-under-test may be as shown in Table 2 below.

TABLE 2

| Korean name | English name | Type | Length | Description |
|---|---|---|---|---|
| Account number | ACC_NO | N | 14 | 14 digits (the first digit is 1) |
| Loan amount | LOAN_AMT | N | 17 | 17 digits |
| Loan rate | LOAN_RATE | N | 8 | The first 5 digits are an |
| | | | | integer part, and the last 3 |
| | | | | digits are a real part |
| Loan date | LOAN_DATE | N | 8 | YYYYMMDD |
| Loan period | LOAN_PERIOD | N | 4 | 4 digits |
| Loan type | LOAN_TYPE | N | 1 | 0—Sraight loan, |
| | | | | 1—Full amortization, |
| | | | | 2—Principal amortization |
| . . . | | | | |

Referring to Table 2, an account table stored in the database may be identified, and information on attributes such as the account number, the loan amount, and the like may be stored.

Here, for example, the account data stored in the account table may be as shown in Table 3 below.

TABLE 3

| ACC_NO | LOAN_AMT | LOAN_RATE | LOAN_DATE | LOAD_PERIOD | LOAN_TYPE | . . . |
|---|---|---|---|---|---|---|
| 1234567890 | 1000000 | 00003300 | 20160322 | 24 | 0 | |
| 1234 | | | | | | |
| 9999999999 | 2000000 | 00004500 | 20160416 | 36 | 0 | |
| 0000 | | | | | | |

Referring to Table 3, account data stored in the database may be identified, and values of the account number, the loan amount, and the like in Table 2 may be stored.

On the other hand, since there may be more than one database table linked to the system-under-test, and the business interest calculation is described as an example, an interest repayment table may be as follows.

TABLE 4

| Korean name | English name | Type | Length | Description |
|---|---|---|---|---|
| Account number | ACC_NO | N | 14 | 14 digits |
| | | | | (the first digit is 1) |
| Repayment date | REPAY_DATE | N | 8 | YYYYMMDD |
| Interest amount | INTEREST_AMT | N | 17 | 17 digits |
| . . . | | | | |

Referring to Table 4, the repayment date according to the account number may be stored in the interest repayment table.

Here, interest repayment data recorded in the interest repayment table may be as follows.

TABLE 5

| ACC_NO | REPAY_DATE | INTEREST_AMT | . . . |
|---|---|---|---|
| 12345678901234 | 20160521 | 2750 | . . . |
| 12345678901234 | 20160421 | 2750 | . . . |
| 99999999990000 | 20160515 | 5500 | . . . |

Referring to Table 5, the repayment date and the interest amount may be stored according to each account number.

Here, the step S200 of generating a test case may include a step S210 of determining at least one program path for the source code, a step S220 of performing the symbolic execution according to the at least one program path, and a step S230 of generating a test case using a solver for a logical expression generated according to the symbolic execution.

Hereinafter, each step may be described in detail with reference to the drawings.

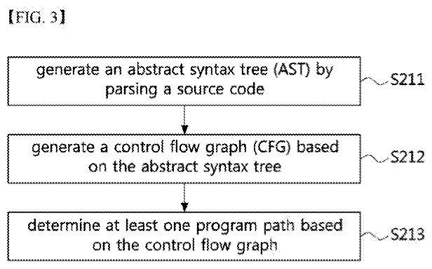

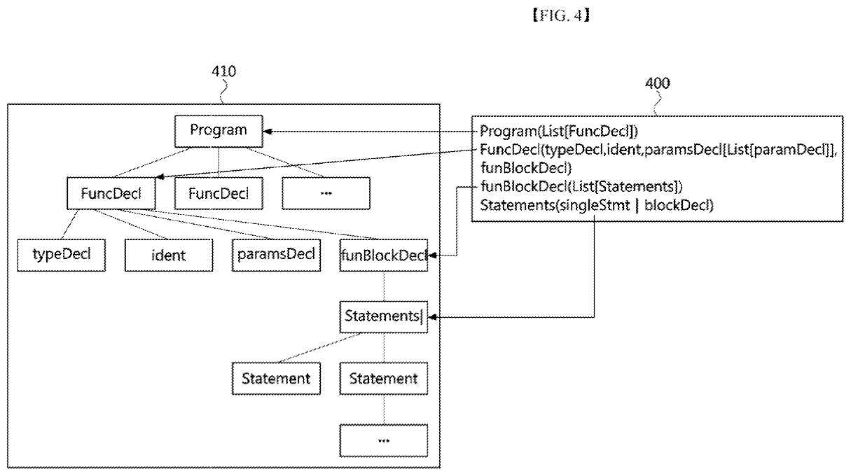

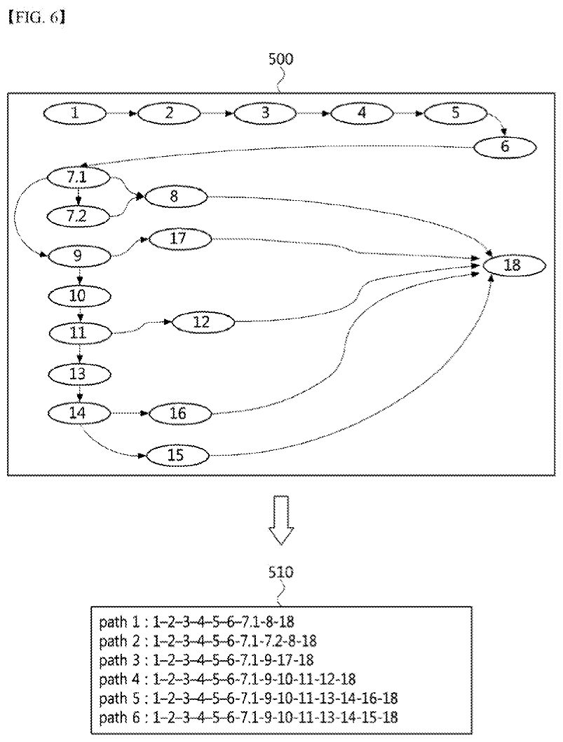

FIG. 3 is a flowchart illustrating a step of determining a program path according to an exemplary embodiment of the present invention. FIG. 4 is a conceptual diagram for explaining an abstract syntax tree (AST) according to an exemplary embodiment of the present invention. FIG. 5 is an exemplary diagram of a source code for deriving a test case according to an exemplary embodiment of the present invention. FIG. 6 is a conceptual diagram for explaining a control flow graph (CFG).

Referring to FIG. 3, the step S210 of determining a program path of FIG. 2 may include a step S211 of generating an abstract syntax tree (AST) by parsing the source code, a step S212 of generating a control flow graph (CFG) based on the generated AST, and a step S213 of determining at least one program path based on the control flow graph (S213).

An abstract syntax is an inductive definition of an abstract syntax tree (AST) composed of operators. The abstract syntax may remove ambiguity of the syntax of the source code using an operator. Further, the abstract syntax tree may be generated by combining different abstract syntax trees with a constructor and an operator.

Detailed description of the abstract syntax tree and the abstract syntax may refer to R. Harper (Harper, R., 2005, op. cit.).

Referring to FIG. 4, the abstract syntax tree may be expressed in a structure type 400. When illustrated for convenience of understanding, it may also be expressed in a schematic type 410.

Specifically, the abstract syntax tree has a tree structure, which can be expressed in various forms. For example, it may be implemented using data structures such as ArrayList, List, and Map.

In comparison between the structure type 400 and the schematic type 410 of FIG. 4, the top node may be <Program>. Here, <Program> may be composed of one or more functions, that is, a list. A function may consist of a return type, a function name, parameters, and a block declaration. The parameter may consist of a type and a variable name. The block declaration may consist of zero or more statements. The statement may be a local variable declaration, an assignment, an IF statement, a query statement, or the like. According to an exemplary embodiment of the present invention, since the source code including SQL query statements is targeted, execution of a symbolic operation including the query statements may be the most important factor.

To determine a program path in the abstract syntax tree according to FIG. 4, the abstract syntax tree itself is already be a tree structure, but it may be difficult to determine the program path here since it has multiple nodes.

Therefore, a control flow graph (CFG) may be introduced. The control flow graph may express all paths passing through the program during execution as a graph.

In the graph, each node may represent a basic block and an arrow may be used to indicate a jump. The graph may have an entry block and an exit block. Every line that is an arrow may have an attribute of either of (Outdegree (A) >1) or (Indegree (B) >1), or both.

Also, in the program path determination, a path explosion in which a large number of paths are derived may occur. An independent program path may be used to solve the path explosion problem. The independent program path may not be a combination of specific paths but may be a path that is differentiated from other unique paths. A white-box testing technique called a basis path testing may be used to find an independent program path. In detail. McCabe (i.e., McCabe, T. J., 1976, A Complexity Measure, IEEE Transactions on Software Engineering, Vol. SE-2, Issue 4) may be referred to.

According to the graph theory employed to obtain an independent program path, a node may be a value obtained by adding a decision and a process. An equation for calculating the independent program path by the graph theory may be as follows.

TABLE 6

Independent path = Edges − Nodes + 2
Independent path = Regions + 1
Independent path = Decisions + 1

Referring to Table 6, the independent program path may be derived by adding 2 to the number of edges minus the number of nodes (Edges-Nodes), by adding 1 to the number of regions, or by adding 1 to the number of decisions.

Referring to FIGS. 5 and 6, a control flow graph in which the abstract syntax tree of FIG. 4 is simplified into a binary tree may be described.

Specifically, the control flow graph 500 of FIG. 6 may be generated from the sample source code of FIG. 5 by using the abstract syntax tree of FIG. 4. By visiting the paths of the generated control flow graph, 6 independent program paths 510 may be derived.

Here, the sample source code according to FIG. 5 is used for deriving each of the program paths 510 according to FIG. 6. In FIG. 5, the number of each line may indicate a syntax number. In the syntax number 7, 7.1 and 7.2 are expressed depending on whether each conditional expression (accNo <0, paydate <0) is satisfied in the IF statement. When the IF statement is satisfied, the path may be moved to the syntax number 8. Also, the syntax number 11 may be branched as a conditional statement, and the SQL statement of the syntax number 14 may be branched to different paths depending on whether INSERT is performed or not.

By tracing independent paths according to each syntax, the control flow graph S00) and the corresponding program paths 510 of FIG. 6 may be derived.

The program path derived here may be supplemented with the syntax number and information indicating whether or not it is a branch statement. The syntax number may be used to get an actual syntax to be executed, and the information whether or not the statement is a branch statement may be used to generate constraints on the variables for performing the corresponding path.

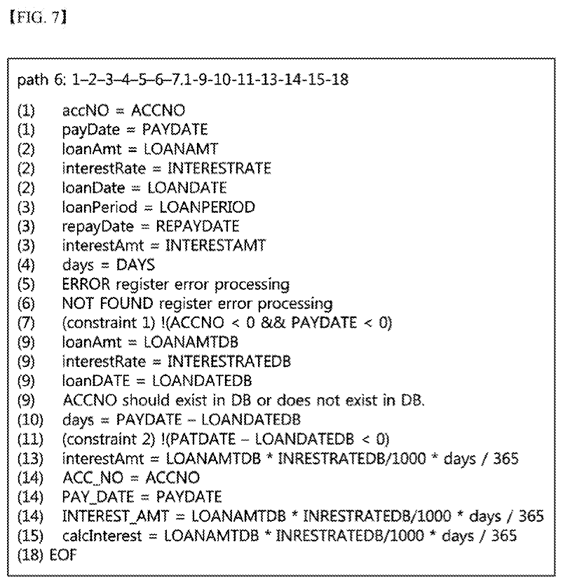

FIG. 7 is a diagram illustrating a result of simulating symbolic execution process for a path 6.

Referring to FIG. 7, the step S220 of performing symbolic execution according to the program path of FIG. 2 may be described in detail.

Specifically, (1), (2), (3), (4), and the like in FIG. 7 may indicate the syntax numbers in FIG. 5, respectively. Since the syntax numbers 1 to 4 in FIG. 5 are for declaring variables when comparing the original source code of FIG. 5 and the symbolic execution result of FIG. 7, (1) to (4) of FIG. 7 may set the variables of the variable declaration section as symbol values. As an example of applying this, if there is no value in the variable declaration section, the variable name may be converted to upper case, and its name may be set to a symbol value. If there is a value in the variable declaration section, its value may be set to an initial value.

When the symbolic execution proceeds, constants, which are numeric values, may be calculated to be a single constant value, and the symbols may remain as variables in the arithmetic expressions. After performing the symbolic execution, one arithmetic expression composed of the symbols may be made. One arithmetic expression satisfying the independent path in FIG. 7 may be a case where the logical expressions (7) and (11) are TRUE. The logical expression generated as a result of such the symbolic execution may then be applied for the solver to derive the condition (constraint) of the value satisfying the corresponding logical expression.

Meanwhile, when the SQL statements are included as in the statement numbers 9 and 14 of FIG. 5, some additional consideration may be needed when performing the symbolic execution. One of them may be analysis and management on host variables. The host variables may be mapped to database columns and used to input (or register) values in the database or to query values from the database. These values may also play an important role in configuring the database environment to enable iterative testing.

Then, it may be necessary to pay attention to a result of the WHERE conditional statement used in the SQL statement. In the case of a SELECT statement, two cases when there are records satisfying a condition and when there are no records satisfying the condition may be additionally considered. Therefore, the number of test cases may vary depending on how many SQL statements are in the independent program path. For example, in the account table, there may have a record in which the value of the ACC_NO column is the same as the value of the host variable accNo, or there may be no record. Therefore, a test case may be made, and values of the corresponding test case may be calculated by considering two cases.

In order to understand the considerations for host variables used in the SQL statements, the four types of SQL statements SELECT, UPDATE, INSERT, and DELETE may be described as follows. In these SQL statements, 3 types of statements including the WHERE clause are SELECT, UPDATE, and DELETE. The conditional clauses of these query statements may correspond to branch statements compared to the existing programming languages, they may be included in the path constraints.

```
TABLE 7
Statement 7: if (accNo < 0 || payDate < 0)
Statement 9: EXEC SQL SELECT LOAN_AMT
                          , INTEREST_RATE
                          , LOAN_DATE
                          , 100
                    INTO :loanAMT, :interestRate; :loanDate, :addin
                    FROM ACC
                    WHERE accNo = :accNo
```

Referring to Table 7, the syntax numbers 7 and 9 in FIG. 5 that is the sample source code are shown. Specifically, the syntax number 7, which is a sample of the IF statement, and the syntax number 9, which is a sample of the SELECT statement, are shown. In order for the execution result of the SQL query statement to be a normal query, the path constraint of the syntax number 7 (IF statement) may need to be changed as follows.

!(accNo <0∥payDate <0)

In the syntax 9, the value of host variable ‘:accNo’ may become a symbol value called ACCNO when performing the symbolic execution. The preceding procedure assumes that symbolic execution is performed in two paths for convenience of explanation.

First, the first pass is a path for generate the test case, and the path may need to be subdivided taking into account the conditions in the WHERE clause of the SQL query statement. When respectively considering the results of the SELECT statement and the INSERT statement of FIG. 6 as two cases of success and failure, the paths the can be derived from the combinations of them may be 3 paths. Considering a pair of SELECT and INSERT, there are three cases: (success and success), (success and failure), failure and failure (or, success). There are four cases for the simple combinations, but if the SELECT fails, the INSERT statement may not give any effect and thus the corresponding case may be excluded.

Meanwhile, when the SQL statement is encountered at a parsing stage of the symbolic execution, the SQL query statement may be parsed to find tables used in the FROM clause, and all the columns constituting the table may be fetched from the metadata of the business database.

TABLE 8

SELECT column_name, data_type, data_length, data_precision,
data_scale, nullable
FROM cols
WHERE table_name=“table name”;

Referring to Table 8, in case of an Oracle DBMS, a SELECT query statement that queries all the columns based on a table name in the metadata of the database may be identified.

TABLE 9
-- Table information query
SELECT table_schema, table_name, table_comment, auto_increment
FROM information_schema.tables
WHERE table_type = ‘BASE TABLE’ AND table_name=<table name>;
-Column information query
SELECT column_comment, column_type, column_key, column_name,
is_nullable
FROM information_schema.columns
WHERE table_name=<table name> AND table_schema=<schema name>

Referring to Table 9, the SELECT query statement of MySQL, that retrieves the column information, which is metadata, by a table name and a schema name, is shown.

After querying the meta-information for all the columns of the table from the database, they may be stored in a table that maps the columns and values.

TABLE 10

| State- | | | | | | |
|---|---|---|---|---|---|---|
| ment | | | Host | | | |
| num- | Table | Column or | variable | Classi- | I- | Val- |
| ber | name | constant | name | fication | tem | ue |
| 7 | ACC | ACC_NO | NULL | Condition | 0 | |
| 7 | ACC | LOAN_AMT | loanAMT | Column | 1 | |
| 7 | ACC | INTEREST_RATE | interestRate | Column | 1 | |
| 7 | ACC | LOAN_DATE | loanDate | Column | 1 | |
| 7 | ACC | LOAN_PERIOD | NULL | Column | 0 | |
| 7 | ACC | LOAN_TYPE | NULL | Column | 0 | |
| 7 | NULL | 100 | addin | Constant | 1 | |

Referring to Table 10, columns and host variable mapping tables for the account table in Table 2 may be identified. The columns in the table may consist of a statement number, a table name, a column/constant, a host variable name, a classification, an item, and a value. Here, the column/constant may have a column name or a constant value. In the case of having a constant value, it may be assumed that a value of 100 is set to adding as shown in Table 7 above.

For example, when the WHERE condition in the SQL query statement is ‘K=?’, ‘?’ may be a host variable, a constant, or a column. If ‘?’ is a host variable, the value of the host variable is a value set earlier in the sequence. Therefore, during the symbolic execution, the value at the time of calculating the expression of the SQL query statement is searched. The value of the host variable may be a constant value, or it may be an arithmetic expression composed of symbols. If ‘?’ is a constant, a value corresponding to a K column is immediately assigned. However, if ‘?’ is an arithmetic expression consisting of symbols, a value for the arithmetic expression should be calculated at this point. If ‘?’ is a column, this may occur in case of a join query. However, the calculation is a bit complicated, but it may be applied in a similar way.

A symbolic execution is performed for the second path.

TABLE 11

| Variable | Initial value | Symbol expression |
|---|---|---|
| calcInterest | CALCINTEREST | CALCINTEREST |
| accNo | ACCNO | ACCNO |
| payDate | PAYDATE | PAYDATE |
| loanAmt | LOANAMT | LOANAMT |
| interestRate | INTERESTRATE | INTERESTRATE |
| loanDate | LOANDATE | LOANDATE |
| loanPeriod | LOANPERIOD | LOANPERIOD |
| Days | DAYS | PAYDATE-LOAN DATE |
| interestAmt | INTEREST | LOANAMT*INTERESTRAE/ |
| | | 1000*(PAYDATE-LOANDATE)/365 |
| addin | 100 | 100 |

Table 11 is a symbol table generated as a result of the symbolic execution. The symbol table may consist of variables, initial values, and symbol expressions.

When executing the line 7 in FIG. 7, the path constraints may be as follows.

PC1: !(ACCNO <0∥PAYDATE <0)

When executing the line 9 in FIG. 7, a list of columns in the ACC table, which is a table extracted from the FROM clause of the SELECT statement, may be obtained, and a mapping table of columns and variables of INTO clauses as shown in Table 12 below.

TABLE 12

| Statement | | Column and | INTO |
|---|---|---|---|
| number | Table | constant | variable |
| 7 | ACC | LOAN_ANT | loanAmt |
| 7 | ACC | INTEREST_RATE | interestRate |
| 7 | ACC | LOAN_DATE | loanDate |
| 7 | ACC | 100 | addin |
| . . . | . . . | . . . | . . . |

Referring to Table 12, the variable mapping table of the column and the INTO clause, for which the calculation is performed assuming that the WHERE clause of the current path is true, may be identified.

Table 13 below is a symbol table reflecting values retrieved from the database as a result of executing the SELECT statement according to line 9 in FIG. 7.

TABLE 13

| Variable | Symbol | Symbol expression |
|---|---|---|
| calcInterest | CALCINTEREST | CALCINTEREST |
| accNo | ACCNO | ACCNODB |
| payDate | PAYDATE | PAYDATE |
| loanAmt | LOANAMT | LOANAMTDB |
| interestRate | INTERESTRATE | INTERESTRATEDB |
| loanDate | LOANDATE | LOANDATEB |
| loanPeriod | LOANPERIOD | LOANPERIODDB |
| days | DAYS | PAYDATE-LOANDATE |
| interestAmt | INTERESTAMT | LOANAMT*INTERESTRATE/ |
| | | 1000*(PAYDATE-LOANDATE)/365 |
| addin | ADDIN | 100 |

Referring to Table 13, the inquired result for each variable is reflected. For example, loanAmt may be the value of LOANAMTDB read from the LOAN_AMT column, and interestRate may be the value of INTERESTRATEDB read from the INTEREST_RATE column.

On the other hand, when the value for the WHERE conditional clause of the SELECT statement is obtained, the value may be obtained according to the type of the condition used in the WHERE conditional clause. The host variable may be registered or modified in a table column structure by searching for a value corresponding to the execution time of the symbolic variable in the symbol table. If the value does not exist in the symbol table, a value may be configured. Once this task is complete, the arithmetic expression consisting of symbols may be calculated again. When it is a constant, the value of the column may be directly registered in the column and the value column of the host variable mapping table as shown in Table 5.

When the line 10 of FIG. 7 is executed, the expression of days may be derived as follows.

days=PAYDATE−LOANDATE

When the line 11 of FIG. 7 is executed, the path constraint may be derived as follows.

PC3: PC2 AND days >0

When the line 13 of FIG. 7 is executed, the expression of interest may be derived as follows

interest=LOANAMT*INTERESTRATE/1000*days/365

When substituting the expression of days in the above equation, the below expression may be derived.

interest=LOANAMT*INTERESTRATE/1000*(PAYDATE−LOANDATE)/365

Table 14 is the mapping table in which the line 14 of FIG. 7 is executed.

TABLE 14

| | | | Host | | | |
|---|---|---|---|---|---|---|
| Stament | Table | Column or | variable | | | |
| number | name | constant | name | Classification | Item | Value |
| 14 | REPAY | ACC_NO | accNo | Column | 1 | ACCNO |
| | | | | name | | |
| 14 | REPAY | REPAY_DATE | repayDate | Column | 1 | PAYDATE |
| | | | | name | | |
| 14 | REPAY | INTEREST_AMT | interestAmt | Column | 1 | LOANAMT*INTERESTRATE/ |
| | | | | name | | 1000*(PAYDATE- |
| | | | | | | LOANDATE)/365 |

Referring to FIG. 14, a column of the repayment table may be inquired, and the column of the repayment table and the host variable mapping table may be generated.

Finally, when the line 15 in FIG. 7 is executed, the expression of calcInterest may be derived as follows.

calcInterest=LOANAMT*INTERESTRATE/1000*(PAYDATE−LOANDATE)/365

After the symbolic execution, if the values in the column and the host variable mapping tables are one symbolic variable, as in Table 10 and Table 14 of the table, a default value may be selected or a value defined in the constraint configured in the database may be selected. For example, the value of LOAN_PERIOD may be derived as a positive value by using a random number, or the value of LOAN_TYPE may be derived by using a value declared in the column constraint or a valid value in a check expression.

In summary, the step S220 of performing the symbolic execution may include a step of mapping a column of a table included in the database according to the host variable and the SQL statement of the source code when at least one program path includes the SQL statement.

Here, the step of mapping step may include a step of parsing the SQL statement to identify a table; a step of acquiring a column constituting the identified table using metadata of the database, and a step of mapping the acquired column to the host variable of the source code.

Hereinafter, the step S230 of generating a test case using a solver for a logical expression generated according to the symbolic execution of FIG. 2 will be described in detail.

The step S230 of creating a test case using a solver may further include a step of converting the generated logical expression into a Satisfiability Modulo Theories (SMT) language. This step may be a step of converting the constraint according to the logical expression into a form that the solver can understand. Here, the solver may be, for example, Z3 disclosed by Microsoft.

Also, the process of converting to SMT language may refer to Moura et al. (Moura, L. De, Bjerner, N., 2008, Z3: An Efficient SMT Solver, 14th International Conference, TACAS 2008, pp. 337-340) and Brummayer et al. (Brummayer, R., Biere, A., 2009, Boolector: An Efficient SMT Solver for Bit-Vectors and Arrays, Proceedings of the 15th International Conference on Tools and Algorithms for the Construction and Analysis of Systems:Held as part of the Joint EuropeanConference on Theory and Practice of Software, pp. 174-177) in detail.

Referring back to FIG. 7, in the symbolic execution of the path 6, since the constraints to be calculated in the statement line 11 should satisfy both (7) and (11), the following may be derived.

PC2 AND days >0=>!(ACCNO <0∥PAYDATE <0) && !((PAYDATE−LOANDATEDB)<0)

Table 15 shows the results of converting the above constraints into the SMT language.

TABLE 15

(ste-option :print-success false)
(set-logic QF_LIA)
(declare-fun ACCNO ( ) Int)
(declare-fun PAYDATE ( ) Int)
(declare-fun LOANAMTDB ( ) Int)
(declare-fun INTERESTRATEDDB( ) Int)
(declare-fun LOANDATEDB ( ) Int)
(assert (not (or (< ACCNO 0) (< DAYDATE 0)))
(assert (not ((< (sub PAYDATE LOANDATEDB) 0))
(check-sat)
(get-value (ACCNO PAYDATE LOANDATEDB))

Referring to Table 15, a script converted from the constraint to the SMT language, which is a form that the solver can understand, may be identified, and when the solver executes the converted script, a value corresponding to the symbolic variable may be obtained. First, values of the symbols corresponding to the input and the output of the function may be obtained. In the previous example, the concrete values of accNo and payDate, which are inputs of the function, may be derived by calculating the symbols ACCNO and PAYDATE, respectively. Here, LOANDATEDB may refer to a constant value retrieved from the database, not a symbol.

Meanwhile, the test case in the present invention may include the database setting values so as to be applicable to a system interworking with the database. Therefore, a method of generating the database setting values will be described below.

The database setting values may be generated in the form of INSERT, UPDATE, or DELETE statements. For each test run, these queries may be performed for the tables used by the business program to generate a database state just before the test runs.

TABLE 16

INSERT INTO ACC
VALUES ACC_NO = <accNo>
, LOAN_AMT = <loanAmt>
, INTEREST_RATE = <ineterestRate>
, LOAN_DATE = <loanDate>
, LOAN_PERIOD = <arbitrary value>
, LOAN_METHOD = < arbitrary value >;
UPDATE acc
SET ACC_NO = <accNo>
, LOAN_AMT = <loanAmt>
, INTEREST_RATE = <ineterestRate>
, LOAN_DATE = <loanDate>
, LOAN_PERIOD = < arbitrary value >
, LOAN_METHOD = < arbitrary value >
WHERE ACC_NO = <accNo>;

In order to test a case where a query result of the SELECT statement exists, the query statement shown in Table 16 may be generated as the database setting value. In case that the account table should have data at the time of test execution, if there is no record in the table, the record may be newly registered with the INSERT statement, and if there is data, the value of the corresponding record may be modified with the UPDATE statement.

TABLE 17

DELETE FROM acc
WHERE ACC_NO = <accNo>;

In order to test a case where the result of the SELECT statement does not exist, the query statement shown in Table 17 may be generated. Regardless of whether a record is in the account table or not, a record may be explicitly deleted by executing the DELETE statement.

TABLE 18

INSERT INTO repay
VALUES ( ACC_NO = <accNo>
, REPAY_DATE = <TODAY>
, REPAY_AMT = <repayAmt> );
UPDATE repay
SET ACC_NO = <accNo>
, REPAY_DATE = <TODAY>
, REPAY_AMT = <repayAmt>
WHERE ACC_NO = <accNo>;

In order to configure the database environment in case of performing redundancy test on the INSERT statement of line 14 of FIG. 7, the query statement as shown in Table 18 may be generated.

Referring to Table 14, when there is no record in the REPAY table at the time of test execution, the INSERT statement may be executed to register a record. When there is a record, the value of that record may be changed by executing the UPDATE statement.

TABLE 19

DELETE FROM repay
WHERE ACC_NO = <accNo>;

Table 19 is a query statement for configuring a database environment for testing a case where the INSERT statement normally registers. Referring to Table 19, a record may be deleted from a table regardless of whether or not the corresponding record exists in the repayment table so that the corresponding record does not exist in the table.

The number of test cases in the program path 6 derived from FIG. 6 is 3, and the test cases may be multiplied by approximately 2 in each SQL query statement. Thus, the number of test cases may be arithmetically generated by 2^{(the number of queries)}, and the test cases generated by the program path 6 may be summarized in Table 20 below.

TABLE 20

| Test path 6 | | Input values | Database setting values |
|---|---|---|---|
| 6-1 | A case of having | accNo = 12345678901234 | INSERT INTO ACC VALUES |
| | account and not | payDate = PAYDATE | (ACC_NO = <accNo>, |
| | repaying interest | | LOAN_AMT = <loanAmt>, |
| | | | INTEREST_RAIL = <interestRate>, |
| | | | LOAN_DATE = <loanDate>, |
| | | | LOAN_PERIOD = arbitrary value, |
| | | | LOAN_METHOD = arbitrary value; |
| | | | DELETE FROM REPAY WHERE |
| | | | ACC_NO = <accNo>; |
| 6-2 | A case of having | accNo* = 12345678901234 | INSERT INTO ACC VALUES |
| | account and | payDate = PAYDATE | (ACC_NO = <accNo>, |
| | repaying interest | | LOAN_AMT = <loanAmt>, |
| | | | INTEREST_RATE = <interestRate>, |
| | | | LOAN_DATE = <loanDate>, |
| | | | LOAN_PERIOD = arbitrary value, |
| | | | LOAN_METHOD = arbitrary value; |
| | | | INSERT INTO REPAY VALUES |
| | | | (ACC_NO = <accNo>, |
| | | | REPAY_AMT = TODAY, |
| | | | INTEREST_AMT = <interestAmt>) |
| 6-3 | A case of having | accNo = 0 | DELETE FROM ACC WHERE |
| | no account | | ACC_NO = <accNo> |
| | | | DELETE FROM REPAY |
| | | | WHERE ACC_NO = <accNo> |

Referring to Table 20, the test case 6-1 may test a case in which an account is held but the interest has not been repaid. In this case, the input values may be 12345678901234 which is the account number registered in the table and PAYDATE which is the result of the symbolic execution. In addition, as the database setting values, an INSERT statement may register an account, a DELETE statement may delete a history of interest repayments, and the values of LOAN_PERIOD and LOAN_METHOD of the INSERT statement may be set to arbitrary values or inquired results of the account table.

The test case 6-2 may a case in which an account is held and the interest has been reapid. The input values may be the same as those of the test case 6-1, and the database setting values may be registering the account and the interest repayment history as the INSERT statements. In this case, REPAY_DATE may be set using a macro called TODAY. The test case 6-3 may test a case where no account is held. Accordingly, in this case, as an input value, 0, which is an account number that does not exist in the account table, may be used, and as the database setting values, the account and the interest repayment history may be all deleted by the DELETE statements.

Some database setting values may be computed by the symbolic computation, but some of them may not be computed by the symbolic computation. These may be referred to as free variables. Any values are acceptable, but the free variables may be generated close to actual values by referring to the constraints of the database or information on a transaction log generated through previous executions of the application, so that realistic values can be generated as much as possible.

Meanwhile, in order to check accuracy of the test, the test case according to the present invention may include an expected output value (or, expected result value) for confirming an output value corresponding to an input value, and an expected database result value (or, expected confirmation value) for confirming a value actually stored in the database as a result of the test.

Table 21 is a table of the expected output values and the expected database result values to confirm the test results.

TABLE 21

| Test path 6 | | Expected result value | Expected database confirmation values |
|---|---|---|---|
| 6-1 | A case of having | calcInterest = | SELECT ACC_NO ∥ |
| | account and not | LOANAMTDB* | <accNo>, |
| | repaying interest | INTEREST | LOAN_AMT ∥ <loanAmt>, |
| | | RATEDB*(PAYDATE- | INTEREST_RATE ∥ <interestRate>, |
| | | LOANDATEDB)/365 | LOAN_DATE ∥ <loanDate>, |
| | | | LOAN_PERIOD ∥ arbitrary value, |
| | | | LOAN_METHOD ∥ arbitrary value |
| | | | FROM acc |
| | | | WHERE ACC_NO = <accNo>; |
| | | | SELECT INTEREST_RATE ∥ NULL |
| | | | FROM repay |
| | | | WHERE ACC_NO = <accNo> |

Referring to Table 21, the expected output value (or, expected result value) may be a return value of the function. Specifically, the value for calcInterest, which is the expected output value (or, expected result value) in the test case 6-1, may be derived from PAYDATE, which is the result of the symbolic execution, and LOANAMTDB, LOANDATEDB, and INTERESTRATEDB, which are retrieved from the database.

Also, the expected database result value (or, expected confirmation value) may be generated by the SELECT statement. The expected database result value may be used to check whether the expected result value of the database is equal to the actual result value by dividing a delimited string (e.g., ‘a∥b’), which is the result value output from the execution of the SELECT statement, by using a delimiter (‘∥’), and comparing the values on the left and right.

In addition, the test cases 6-2 and 6-3 are for cases in which the expected result value is a returned error value. In this case, the expected database result value (or, expected confirmation value) may be generated as shown in Table 20, or not generated at all.

In summary, the automatically-generated test case may generate an expected output value corresponding to an input value and generate an expected database result value corresponding to the database setting value to confirm the test result. Also, after the step S300 of generating the test case of FIG. 2, the method may further include a step of storing the generated test case in one of XML and JSON formats. However, not being limited thereto, and the test case may be stored in a form of a string, a binary, or the like.

In this case, information on a location in which the test case is to be stored may be referred to by assigning an ‘info’ tag, and the test case may be stored as having a primary key of a path, a file name, a method name, and a test case number, which are the location information that the info tag has.

Also, the test cases need to be synchronized as the system-under-test changes.

One of the synchronization methods is to change all the test cases immediately after the change of the system-under-test, and another method is to change the test cases by synchronizing them at the time of executing the test. The first method has an advantage that the system-under-test always matches with the test cases, but in case of massive changes, there may be a disadvantage of affecting the overall performance of the test. The second method may have a disadvantage that the test execution time is lengthened because the synchronization is performed at the execution time.

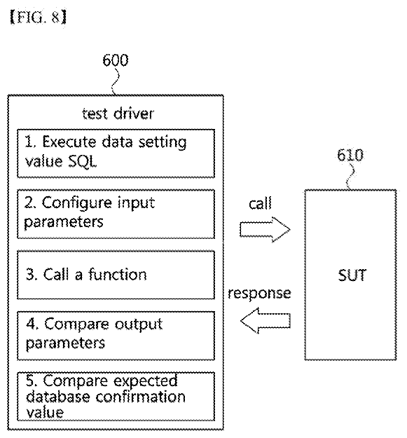

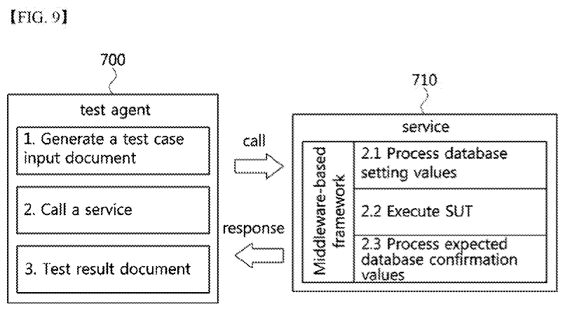

FIG. 8 is a first exemplary diagram illustrating a process of performing a test according to an exemplary embodiment of the present invention. FIG. 9 is a second exemplary diagram illustrating a process of performing a test according to an exemplary embodiment of the present invention.

Referring to FIGS. 8 and 9, a process of performing a test in different ways according to the type of the system-under-test may be described.

The system-under-test according to the present invention may be a service or a module.

First, referring to FIG. 8, a method of performing a test when the system-under-test (SUT) is a module may be described.

A method of generating a test driver to be executed when the test is performed may vary depending on the type of the system-under-test. The system-under-test may be provided in form of a source code or an object code, or in form of a shared library. When the system-under-test is provided in the form of a source code or an object code, a build (compile and linking), including the system-under-test, should be performed, which may complicate a build environment. In this case, there is a disadvantage that the system-under-test is built with the test driver as one body and executed, and the test build is not performed when there is an error in the system-under-test. When the system-under-test is provided in the form of a shared library, a dynamic call of the module may be used for execution of the test. The presence of the shared library of the corresponding module may mean that there is no error in the module to be tested.

Referring to FIG. 8, a method for performing a test, when the system-under-test is a module, may comprise a step of applying the database setting value included in the test case to the database, a step of configuring an input parameter of the system-under-test with the input value included in the test case, a step of calling a function of the system-under-test with the configured input parameter; and a step of comparing an output value of the system-under-test obtained as a result of calling the function with the expected output value included in the test case, and comparing a result value stored in the database with the expected result value included in the test case.

Here, each step may be performed by executing the compiled test driver.

Here, since the structures consisting of the output value and the expected output value of the system-under-test and the tables and columns of the database may be changed at any time during the development process, a function of detecting the change and synchronizing in real time may be further supported.

As described above, the test method by the generation of the test driver has the advantage that the test manager can directly control the transactions and the test can be performed without completely configuring the actual test environment.

TABLE 22

```
int main ( int c, char *v[ ]) {
//1. Call a DB preimage execution module
/*
  INSERT INTO ACC VALUES (ACC_NO = accNo
  , LOAN_AMT = LOANAMTDB
  , INTEREST_RATE = INTERESTRATEDB
  , LOAN_DATE = LOANDATEDB
  , LOAN_PERIOD = arbitrary value
  , LOAN_METHOD = arbitrary value;
  DELETE FROM REPAY WHERE ACC_NO = accNo;
/
doPreImage(program number, test case number);
//2. Set an input value of a test case
int accNo = 0;
int date = PAYDATE;
ret = calcInterest(accNo, date);
//3. Compare a test case result value
compareWriteInteger(program number, test case number, ret,
expected interest);
//4. Compare a DB postimage
Postimage = SELECT ACC_NO||0, LOAN_AMT||LOANAMTDB
  , INTEREST_RATE||INTERESTRATEDB
  , LOAN_DATE||LOANDATEDB
  , LOAN_PERIOD||arbitrary value
  , LOAN_METHOD||arbitrary value;
compareWriteSQL(program number, test case number, postimage);
```

Table 22 shows a source code for the test method using the test driver. Referring to Table 22, a setting value may be input to the database, an input value of the test case may be input as a function parameter of the system-under-test, and the result according to it may be compared.

On the other hand, referring to FIG. 9, a method of performing a test, when the system-under-test is a service, may be described.

Specifically, a method of performing a test, when the system-under-test is a middleware service, may comprise a step of generating an input document using the test case, a step of calling a service of a middleware with which the system-under-test interworks, and transmitting the input document to the middleware, and a step of receiving a test result document from the middleware.

Here, since the input document may be pre-stored in form of XML, JSON, etc. once the test case is generated, the step of generating the input document may be processed as a step of obtaining the stored document.

Also, the method may further include a step of converting the input document into a format supported by the middleware service after the step of generating the input document. This may be to ensure compatibility because the format of the input document that stores and uses the test case may differ from the format supported by the middleware service.

Here, the middleware used to develop the system-under-test may be Socket, RMI, RPC, HTTP, TUXEDO, T-max, Entera, or the like. The method of calling a service may be determined, and a method of controlling transactions may be changed according to the middleware used by the developed system-under-test. Since the commercial middleware, such as TUXEDO and T-max, provides 2-phase commit, at the time of testing, transactions related to testing tasks and business tasks such as configuration of a database environment, processing of expected results, and storing of test results in the database can be effectively controlled. Also, if the system-under-test uses a framework, the system-under-test can provide a more structured form. The framework allows calling of intercept routines such as preprocessing and post-processing in order to process a business transaction, and executes functions used commonly before calling the service. By embedding a module that configures a database environment and processes expected results in such the preprocessing and post-processing, the transaction can be effectively processed.

Table 23 is a sample code for testing a middleware-based system-under-test.

TABLE 23

```
  int RunServiceByXML (char *project: char* tcNo) {
  //1. Generate an input document
  inputXML = readInputXML(project, tcNo)
  //2. Call a service
  ret = callService(inputXML)
  //3. Generate a result document
  outputXML = readOutputXML(project, tcNo)
  //3. Compare results
  expectedXML =readExpectedXML(project, tcNo);
  compareWriteXML(outputXML, expectedXML);
  //4. Compare DB results
  Result record = SELECT * FROM REPAY WHERE ACC_NO = accNo
  compareWriteSQL(result recore, expeeted record);
  }
//A transaction for a business DB starts in a framework
//A transaction for a test DB starts and ends as a self-transaction
//Module for processing a DB input (called in a framework preprocessing)
int dbInput(project, tcNo) {
  //SQL query by the test DB to the business DB for inputting
  //Execute SQL in the business DB
  //When an error occurs, store the error in the test DB
  //Commit or rollback the test DB
}
//Module for processing DB results (called in a framework post-processing)
int dbOutput(project, tcNo) {
  //SQL query by the test DB to the business DB for result comparison
  //Execute SQL in the business DB for result query
  //Compare result DB values and expected DB result values
  //Store test results in the test DB
  //Commit or rollback the test DB
}
```

Referring to Table 23, each process in the test agent side and each process performed by the framework of the middleware may be identified.

When describing the above process in detail, first, the test agent may inquire the input document of the test case with the program number and the test case number, and configure a value in a reserved region of the input document.

Second, the test agent may call the service by transmitting the input document to the framework. The framework may forward the program number and the test case number, which are included in the reserved region of the document, to a preprocessing module of the service. The preprocessing module of the service may read the database setting values from the database storing the test case by using the program number and the test case number, and configure a pre-test environment before the test execution. Then, the framework may call the system-under-test (SUT) to execute business logics. The SUT may perform business processing while manipulating data in an interworking business database. Finally, the framework may retrieve the expected database result values with the program number and the test case number. Also, queries may be performed on the business database to verify the accuracy of the test by comparing the expected result values and actual result values. In each of the above steps, information necessary for managing the results of the test may be recorded in the test database.

Third, a test case result document processing module may inquire the test result of the test case with the program number and the test case number. The test case result document processing module may compare the expected output values with the actual output values, and store the result in the database in which the test case is recorded.

Therefore, the middleware (or, the framework of the middleware) may be configured to identify the database setting value of the test case from the input document, perform an initial setting on the database using the identified database setting value, identify the input value of the test case from the input document, and execute the system-under-test by inputting the input value of the test case as an input parameter of the system-under-test.

The middleware-based test method can make the test agent using a generalized module without generating a source code. Also, if the business system is developed using the framework, there is an advantage of using the 2-phase commit transaction management.

Here, there are values that cannot be statically defined among the test results. For example, information that changes each time the test is run, such as a serial number generated or a date or a time at which the test is run, may increase the uncertainty of the test results. Accordingly, it may be difficult to clearly define and test the expected output value or the expected result value of the database as a test case therefor.

In this case, such the information may not be a target of determination of the test result, and it may be defined as a value such as a macro, a reference, and a script, and may be processed with a logic. Also, the value may be input as a type separated according to a constant value, a macro, a reference, or a script. For example, the constant value may be a number or a string, the macro may be defined as a predefined name such as TODATE, and in case of such as a current date, a system's current date may be inquired and used. The reference may retrieve a value of a specific column of the document, which is the form where the test case is stored. The script may compare the result value of executing the script with the output value. However, the script may have a meaning that includes the macro.

Therefore, when the output value is changed at each execution of the system-under-test, the expected output value may be excluded from the test case or determined by one of the macro, the reference, and the script.

Meanwhile, various test schemes may be applied to the process of performing the test using the test case generated above. The test schemes may include unit test, integration test, or regression test.

First, the unit test may be a software testing scheme of testing individual units of the source code. Here, the unit is the smallest unit of an application and may mean a set of lines that can be tested. The unit test is a test scheme for finding problems at the initial stage of development, and is aimed at finding defects or misses in a bug or specification made by a programmer at the time of implementation. A module that has been unit-tested may be guaranteed to work correctly when used in the regression test. Thus, a test case for the unit test may be written for a program that is likely to have a defect. This test case for the unit test, which has been written as described above, may be used not only in the regression test for the unit-tested program but also in the integration test requiring integration of stable modules. However, the unit tests may not detect all errors in the program. Since only the functions of the unit itself are tested, errors such as integration errors and system errors may not be found.

Referring again to FIG. 1, the automatically-generated test case may be used in the unit test. The test case generated by the symbolic executor may be first stored in the test DB. At this time, the user and the administrator may manage the automatically-generated test case by assigning an appropriate name as described above.

The user and the administrator may use them at any time, and may check the test results immediately when they want. If the automatically-generated test case is applied to a test that requires accuracy, many tests can be performed with little effort, and the test coverage can be maximized. Finally, the unit test results may be automatically aggregated in the test database and accumulated as statistics, which can provide information to the administrator in an easy to understand manner in real time.

Then, the integration test may be defined as a software testing method of performing a test by connecting unit modules or services in a sequence. The integration test is aimed at the unit-test programs, and may be performed by an analyst or a designer prior to verification testing, such as a pilot or spot testing.

The integration test methods may include a big bang scheme, a top-down scheme, a bottom-up scheme, and a hybrid scheme. The big band scheme is a scheme of testing developed modules by integrating all of them at once. The big bang scheme has an advantage of shortening the integration test time, but when the unit programs are not fully tested, it may take more time and effort. The bottom-up scheme is a scheme of integrating and testing the lowest units first. The testing may be performed up to the top unit by repeating procedures such as directly testing an upper unit when all the lower units related to the upper unit to be tested are tested. The top-down scheme allows testing from the top level. Then, the lower units may be tested repeatedly. The hybrid scheme may be a scheme in which the bottom-up scheme and the top-down scheme are mixed. In the integration test, conditions not described in the integration test specification may not be tested. Using the automatically-generated test cases, developers can configure module integration or service integration testing.

A module integration test may be performed by aggregating modules in sequence. In other words, a test driver that aggregates the modules in sequence may be generated. When testing a top-level function in a module, lower functions may be called and executed. A user registration module, a user list query module, a user modification module, and a user deletion module may be configured and tested according to a scenario.

A service integration test is a scheme of aggregating and testing services in sequence. Assuming that a user registration service, a user list query service, a user modification service, and a user deletion services are configured according to a scenario as in the module integration test, the tester may select a test case of registering a user in the test DB. Then, in order to check whether the user is normally registered, a test case of inquiring the user list with the registered user number may be selected. Then, a test case for modifying the information of the registered user may be selected. Here, the same user number may be designated so as to perform a test of modifying to the same user number. Finally, a user deletion test case for testing user deletion may be selected. Similarly, the same user number may be designated so as to test the deletion.

Thus, the unit test cases may be combined to perform the service integration test. Since the test cases constituting the scenario should use the same user number, a method of using the user number registered in the user registration test case in the later test cases may be provided. One of the simplest methods to do this is to provide a method for referring to the input value or the actual output value previously used in the test case for accuracy determination.

As the results of the integration test, the results of individual test cases constituting the scenario should be managed, as well as the result of the entire scenario. Also, it may be necessary to manage the test result of one scenario, the history of the test scenario, and the history of the change of the scenario. The administrator may be interested in the success of the entire scenario, and the developer is interested in finding out where the failure of the scenario occurs, and the reason for the failure.

The regression test is a software testing technique for identifying whether or not the previously-developed software still works well after a change if the software. The change of the software may be caused by improvements, patches, and configuration changes. The regression test may be aimed at finding regression errors caused by new bugs or the program changes (referring collectively to additions, deletions, and modifications).

As the regression test scheme, there are a scheme of executing all the test cases, and a scheme of finding and testing a program affected by the program changes. The scheme of executing all the test cases is ideal, but it may be difficult to use the scheme when a test time constraint, such as that the test should be completed within 8 hours, exists.

A regression analysis is used to find out the influences of program changes through an impact analysis. The analysis results are used to select a regression test case, and the regression test may be performed using the results of regression analysis. In the regression test, it may be advantageous to perform the test by finding out a test case of a program affected by the program change.

To explain a method for the regression analysis at a function (or method) level, a function affected by the program change may be found out, and this may be repeated until all parent functions using the corresponding function and all parent function of them are found out. Once all the affected functions are found out, redundant functions may be removed. Finally, test cases belonging to the remaining functions may be executed sequentially.

The test cases used in the regression test may be in form of the unit test case or the integrated test case. The regression test may use all possible test cases and also specify the test cases to be used in the regression test for efficient testing. The result of the regression test may be stored in the test DB. Also, when an error in connection with the payment system occurs, it is also possible to prevent the changed program from being loaded into the operating system.

The regression test may be a test that should be performed in an iterative incremental development method. In the iterative incremental development, a developed program may be committed to a configuration management system every day, and an automated build system downloads the program from the configuration management, builds, finds affected functions through the impact analysis, and executes the corresponding test cases. Such the operations may be repeated.

As an example of the impact analysis, it is assumed that a column is to be deleted from the business table first. An impact analysis system may find a function that uses the deleted column (in this case, a program including the function is also found). These operations may be repeated until all the parent functions that use the corresponding function. The redundant functions may be removed among the found functions. Using a list of the functions after removing the redundant functions, test cases belonging to the functions may be found. All of these test cases may be executed to complete the regression test.

One of the most important factors in the impact analysis may be to obtain the minimum set of affected test cases. Static analysis techniques may be used to achieve this goal. The static analysis techniques may be used to trace the corresponding control flows to find affected basis paths, find the test cases associated with them, and extract the minimal set of test cases.

A test case generating apparatus according to an exemplary embodiment of the preset invention may comprise a processor executing at least one instruction and a memory storing the at least one instruction.

Here, the processor may be, based on symbolic execution, configured to determine at least one program path for a source code including a structured query language (SQL) statement based on symbolic execution based on symbol execution, perform the symbolic execution according to the at least one program path, and generate a test case by using a solver for a logical expression generated according to the symbolic execution.

Here, the processor may be configured to generate an abstract syntax tree (AST) by parsing the source code; generate a control flow graph (CFG) based on the generated abstract syntax tree, and determine the at least one program path based on the control flow graph.

A test apparatus using a test case according to an exemplary embodiment of the preset invention may comprise a processor executing at least one instruction and a memory storing the at least one instruction.

Here, the processor may be, based on symbolic execution configured to generate a test case for a source code including a structured query language (SQL) statement based on symbolic execution, and perform a test by applying the test case to a system-under-test, which interworks with a database. Also, the test case may include at least one of an input value of a system-under-test, an expected output value predicted as an output value when the input value is processed in the system-under-test, a setting value for a database, and an expected result value predicted to be stored in the database when the system-under-test interworks with the database to which the setting value is applied.

Here, the processor may be configured to determine at least one program path for the source code, perform symbolic execution according to the at least one program path, and generate a test case by using a solver for a logical expression generated according to the symbolic execution.

Here, the processor may be configured to generate an abstract syntax tree (AST) by parsing the source code; generate a control flow graph (CFG) based on the generated abstract syntax tree, and determine the at least one program path based on the control flow graph.

Here, the processor may be, when an SQL statement is included in the at least one program path, configured to map a column of a table included in the database according to a host variable and the SQL statement of the source code.

Here, the processor may be configured to parse the SQL statement to identify the table, acquire the column constituting the identified table using metadata of the database, and map the acquired column to the host variable of the source code.

Here, the processor may be configured to store the generated test case in one of XML and JSON formats.

Here, the processor may be, when the system-under-test is a module, configured to apply the setting value to the database, configure an input parameter of the system-under-test with the input value, call a function of the system-under-test with the configured input parameter, and compare an output value of the system-under-test obtained as a result of calling the function with the expected output value, and compare a result value stored in the database with the expected result value.

Here, the processor may be, when the system-under-test is a middleware service, configured to generate an input document using the test case, call a service of a middleware with which the system-under-test interworks, and transmit the input document to the middleware; and receive a test result document from the middleware.

The above-described test case generating apparatus or the test apparatus using a test case may be a desktop computer, a laptop computer, a notebook, a smart phone, a tablet PC, a mobile phone, a smart watch, a smart glass, an e-book reader, a portable multimedia player (PPMP), a portable gaming machine, a navigation apparatus, a digital camera, a digital multimedia broadcasting (DMB) player, a digital audio recorder, a digital video recorder, a digital video player, a personal digital assistant (PDA), or the like which has communication capability.

The embodiments of the present disclosure may be implemented as program instructions executable by a variety of computers and recorded on a computer readable medium. The computer readable medium may include a program instruction, a data file, a data structure, or a combination thereof. The program instructions recorded on the computer readable medium may be designed and configured specifically for the present disclosure or can be publicly known and available to those who are skilled in the field of computer software.

Examples of the computer readable medium may include a hardware device such as ROM, RAM, and flash memory, which are specifically configured to store and execute the program instructions. Examples of the program instructions include machine codes made by, for example, a compiler, as well as high-level language codes executable by a computer, using an interpreter. The above exemplary hardware device can be configured to operate as at least one software module in order to perform the embodiments of the present disclosure, and vice versa.

While the embodiments of the present disclosure and their advantages have been described in detail, it should be understood that various changes, substitutions and alterations may be made herein without departing from the scope of the present disclosure.

1. A test method using a test case, the test method comprising:
generating a test case for a source code including a structured query language (SQL) statement based on symbolic execution; and
performing a test by applying the test case to a system-under-test, which interworks with a database,
wherein the test case includes at least one of an input value of the system-under-test, an expected output value predicted as an output value when the input value is processed in the system-under-test, a setting value for the database, and an expected result value predicted to be stored in the database when the system-under-test interworks with the database.

2. The test method according to claim 1, wherein the generating of the test case comprises:
determining at least one program path for the source code;
performing the symbolic execution according to the at least one program path; and
generating the test case using a solver for a logical expression generated according to the symbolic execution.

3. The test method according to claim 2, wherein the determining of the at least one program path comprises:
parsing the source code to generate an abstract syntax tree (AST);
generating a control flow graph (CFG) based on the generated abstract syntax tree; and
determining the at least one program path based on the control flow graph.

4. The test method according to claim 2, wherein the performing of the symbolic execution comprises, when an SQL statement is included in the at least one program path, mapping a column of a table included in the database according to a host variable and the SQL statement of the source code.

5. The test method according to claim 4, wherein the mapping comprises:
parsing the SQL statement to identify the table;
acquiring the column constituting the identified table using metadata of the database; and
mapping the acquired column to the host variable of the source code.

6. The test method according to claim 1, further comprising, after the generating of the test case, storing the generated test case in one of XML and JSON formats.

7. The test method according to claim 1, wherein when the system-under-test is a module, the performing of the test case comprises:
applying the setting value to the database;
configuring an input parameter of the system-under-test with the input value;
calling a function of the system-under-test with the configured input parameter; and
comparing an output value of the system-under-test obtained as a result of calling the function with the expected output value, and comparing a result value stored in the database with the expected result value.

8. The test method according to claim 1, wherein when the system-under-test is a middleware service, the performing of the test case comprises:
generating an input document using the test case;
calling a service of a middleware with which the system-under-test interworks, and transmitting the input document to the middleware; and
receiving a test result document from the middleware.

9. The test method according to claim 8, wherein the middleware is configured to:
identify the database setting value of the test case from the input document;
perform an initial setting on the database using the identified database setting value;
identify the input value of the test case from the input document; and
execute the system-under-test by inputting the input value as an input parameter of the system-under-test.

10. The test method according to claim 1, wherein when an output value of the system-under-test is changed at each execution of the system-under-test, the expected output value is excluded from the test case, or determined by one of a macro, a reference, or a script.

11. An apparatus for generating a test case, the apparatus comprising a process executing at least one instruction and a memory storing the at least one instruction, wherein when the at least one instruction is executed, the processor is configured to:
determine at least one program path for a source code including a structured query language (SQL) statement based on symbolic execution;
perform the symbolic execution according to the at least one program path; and
generate a test case by using a solver for a logical expression generated according to the symbolic execution.

12. The apparatus according to claim 11, wherein the processor is further configured to:
generate an abstract syntax tree (AST) by parsing the source code;
generate a control flow graph (CFG) based on the generated abstract syntax tree, and
determine the at least one program path based on the control flow graph.

13. A test apparatus using a test case, the apparatus comprising a process executing at least one instruction and a memory storing the at least one instruction, wherein when the at least one instruction is executed, the processor is configured to:
generate a test case for a source code including a structured query language (SQL) statement based on symbolic execution; and
perform a test by applying the test case to a system-under-test, which interworks with a database,
wherein the test case includes at least one of an input value of the system-under-test, an expected output value predicted as an output value when the input value is processed in the system-under-test, a setting value for the database, and an expected result value predicted to be stored in the database when the system-under-test interworks with the database.

14. The test apparatus according to claim 13, wherein the processor is configured to:
determine at least one program path for the source code;
perform the symbolic execution according to the at least one program path; and
generate the test case using a solver for a logical expression generated according to the symbolic execution.

15. The test apparatus according to claim 14, wherein the processor is configured to:
parse the source code to generate an abstract syntax tree (AST);
generate a control flow graph (CFG) based on the generated abstract syntax tree; and
determine the at least one program path based on the control flow graph.

16. The test apparatus according to claim 14, wherein when an SQL statement is included in the at least one program path, the processor is configured to map a column of a table included in the database according to a host variable and the SQL statement of the source code.

17. The test apparatus according to claim 16, wherein the processor is configured to:
parse the SQL statement to identify the table;
acquire the column constituting the identified table using metadata of the database; and
map the acquired column to the host variable of the source code.

18. The test apparatus according to claim 13, wherein the processor is configured to store the generated test case in one of XML and JSON formats.

19. The test apparatus according to claim 13, wherein when the system-under-test is a module, the processor is configured to:
apply the setting value to the database;
configure an input parameter of the system-under-test with the input value;
call a function of the system-under-test with the configured input parameter; and
compare an output value of the system-under-test obtained as a result of calling the function with the expected output value, and compare a result value stored in the database with the expected result value.

20. The test apparatus according to claim 13, wherein when the system-under-test is a middleware service, the processor is configured to:
generate an input document using the test case;
call a service of a middleware with which the system-under-test interworks, and transmit the input document to the middleware; and
receive a test result document from the middleware.
